(19) United States
(12) Patent Application Publication
(10) Pub. No.: US 2017/0106751 A1
(43) Pub. Date: Apr. 20, 2017

(54) OPERATING ELEMENT FOR A MOTOR VEHICLE, AND METHOD FOR PRODUCING A GLASS PANEL FOR A TOUCH-SENSITIVE OPERATING ELEMENT

(71) Applicant: AUDI AG, Ingolstadt (DE)

(72) Inventor: Michael WACHINGER, Winkelhausen (DE)

(73) Assignee: AUDI AG, Ingolstadt (DE)

(21) Appl. No.: 15/314,905

(22) PCT Filed: Apr. 30, 2015
(86) PCT No.: PCT/EP2015/000887

§ 371 Date: Nov. 29, 2016

(30) Foreign Application Priority Data
May 30, 2014 (DE) 10 2014 008 200.8

(51) Int. Cl. B60K 35/00; G06F 3/041; C03B 23/03

(52) U.S. Cl. CPC B60K 35/00; C03B 23/0302; G06F 3/041; G06F 2203/04103; B60K 2350/1028

(57) ABSTRACT

A surface structure of a glass panel is formed by deep-drawing the surface in the heated state of the glass panel to provide a touch-sensitive operating surface of an operating element for a motor vehicle. The surface structure has a wave-shaped design, and additionally at least one glass panel surface part which is completely touchable is formed with the surface structure.

### CROSS REFERENCE TO RELATED APPLICATIONS

This application is the U.S. national stage of International Application No. PCT/EP2015/0008887, filed Apr. 30, 2015 and claims the benefit thereof. The International Application claims the benefit of German Application No. 102014008200.8 filed on May 30, 2015, both applications are incorporated by reference herein in their entirety.

### BACKGROUND

Described below is an operating element for a motor vehicle, the operating element having a touch-sensitive operating surface provided by a surface of a glass panel. The surface of the glass panel further has a surface structure formed by deep-drawing of the surface in the heated state of the glass panel. Also described is a method for producing a glass panel for a touch-sensitive operating element. Here, a glass panel and a deep-drawing tool with a first tool part and a second tool part are provided, the glass panel is introduced into the deep-drawing tool between the first tool part and the second tool part, and a surface structure of a first surface of the glass panel is formed by deep drawing the glass panel in the heated state of the glass panel using the deep-drawing tool.

The related art has disclosed touch-sensitive operating elements, such as e.g. touchpads and touchscreens, which may have a glass panel as an operating surface. Here, such glass panels should be as hard and as scratch-resistant as possible, which is facilitated, for example, by specific glass compositions and tempering methods.

By way of example, DE 11 2010 004 720 T5 describes a glass composition which should have high-strength, fracture toughness and high scratch-resistance. Glass panels, which are particularly suitable for touchscreens, may be produced from this glass by floating or a deep-drawing process.

Furthermore, U.S. 2013/0189486 A1 describes a glass composition suitable for fast 3D press forming and tempering in order thereby likewise to be able to provide great hardness, scratch resistance and high resistance to fracturing, in particular for planar and non-planar or bent touchscreen surfaces. Here, it is also possible to generate surface structures during the press forming which have a decorative effect or optical function.

However, in the case of touch-sensitive operating elements, it is not only the robustness and optics of the operating surface that play a role, but also the operating comfort which should be provided with such operating elements in order, for example, to facilitate operation which is as simple and comfortable as possible.

Under this aspect, DE 10 2012 020 609 A1 for example suggests a generic operating element and method, in which a three-dimensional, tactile structure on the glass surface is generated by deep drawing of a heated glass surface for a touchscreen. Here, these structure elements serve to subdivide the operating surface into different segments which may be felt by a user such that a user, for example, may feel a specific operating region formed by the elevated structure elements without having to gaze at the touchscreen. Improved and simplifying operating options of an operating element therefore also have a positive effect on the safety in traffic.

### SUMMARY

Described below are an operating element for a motor vehicle, and a method for producing a glass panel for a touch-sensitive operating element for a motor vehicle, which facilitate a further increase in the use and operating comfort by the operating element.

The operating element described below is distinguished by the surface structure having a wave-shaped embodiment and at least one overall touchable part of the surface of the glass panel being embodied with the surface structure. In particular, the whole surface of one side of the glass panel may also be embodied with a surface structure in this case. Here, advantages have been discovered in relation to the usability and, in particular, in relation to the haptics of an operating device that may be obtained not only by macroscopic structures of the surface which may be felt, but also by a surface-covering formation of a wave-shaped surface structure, like, for example, by fine structuring or microstructuring of the surface. In particular, these advantages are obtained by virtue of the touchable surface not having any plane surface sections as a result of this configuration of the surface of the glass panel. As a result, the sliding properties of the surface may be greatly improved because plane glass surfaces have a very high coefficient of static friction in comparison with an uneven, wave-shaped structured surface. During operation, high values of static friction are expressed, in particular, by virtue of a high resistance being felt initially when reversing the direction of a touching operating movement, or else when briefly resting a finger on the surface, until the desired movement may be carried out, which has a disadvantageous effect on the operating comfort of touch-sensitive operating elements such as touchscreens or touchpads and may very easily lead to incorrect operations. By contrast, a wave-shaped structured surface ensures controlled touching movements on the whole touchable surface of the glass panel and therefore simplifies the operation in a particularly advantageous manner. Moreover, advantages in relation to sliding noises may be obtained, since the surface structure also affects the acoustics of such sliding noises. This is because, advantageously, acoustic damping, in particular of high frequencies, may also be brought about by the roughening of the surface caused by the wave-shaped surface structure, and so, for example, unpleasant squeaking and scratching noises, as often occur in the case of plane, smooth glass surfaces, may be avoided. Moreover, the surface provides huge reductions in the visibility of dirt, such as fingerprints, finger grease, etc. This is brought about, firstly, by the whole surface area of a finger not being placed onto the surface as a result of the wave-shaped surface structure and, secondly, predominantly by the undirected light reflection in contrast to smooth surfaces caused by the wave structure. Hence, only a small fraction of dirt on the surface is even visible at a specific viewing angle. This is advantageous, particularly in the case of the embodiment of the operating element as a touchscreen, as this facilitates a significantly improved identifiability of depictions and displays on the touchscreen. However, another effect, which may be obtained, also contributes to the improved identifiability of depictions and displays displayed through the glass panel. The output coupling efficiency of light radiated into the glass panel may be increased by the wave-shaped surface structure, and so, overall, the degree of transmission of light by the glass panel, and hence of depictions of the operating element displayed through the glass panel, may be increased.

Moreover, glass panels for touch-sensitive operating elements for motor vehicles may be provided with a semi-transparent color coating so as to match the color appearance of the operating element to the color design of the vehicle interior. Now, as a result of the wave structure, the optical properties of the glass panel may be modified in such a way that such a coating is perceived as significantly more intensive, and hence darker, in terms of the color thereof. In turn, this leads to significantly brighter hues, and hence coatings with a higher light transparency, being able to be used as a coating. Hence, this additionally also contributes to a higher degree of transmission of the glass panel and therefore facilitates a more distinct, clearer and, in particular, more light-intensive display of depictions on the operating element. Moreover, improvements in relation to the thermal properties of the glass panel may be obtained. The enlarged surface of the glass panel on account of the wave-shaped surface structure improves the thermal decoupling of the glass panel and the heat of the operating element may thus be dissipated to the surroundings in an improved manner, this being expressed for a user in terms of a significantly cooler operating surface, which is therefore perceived to be more pleasant, and moreover also being accompanied by a positive effect in relation to reduction of too strong heating of the operating device itself. Moreover, the contact surface area of the finger when touching the surface is reduced in relation to a plane surface as a result of the wave-shaped surface structure, and so less friction arises when moving the finger due to the reduced contact surface area and so less frictional heat is transferred to the glass panel as well. This also advantageously allows a reduction in the heating of the glass panel as a result of using the operating element. Hence, significant advantages overall may be obtained in view of the provision of use and operating comfort which is as high as possible.

In an advantageous configuration, the surface structure is embodied as a microstructure. Thus, the wave-shaped surface structure should therefore be wherein wavelengths of the wave structure which are significantly shorter than 1 mm. What such a fine structure may advantageously bring about is the different surface curvatures caused by the wave-shaped surface structure not being accompanied by an optically perceivable distortion of a depiction displayed through the glass panel. Moreover, a particularly pleasant operating sensation may be provided by such fine structuring and, moreover, the aforementioned advantages may be implemented particularly effectively. Moreover, forming the surface structure by a deep-drawing process particularly advantageously provides the option of also implementing such a fine structure. The formation of the surface structure by a deep-drawing process is particularly advantageous, precisely when forming a glass panel with such fine structuring. In contrast to directly processing the glass surface, the surface structure may, firstly, be generated very sparingly without straining or damaging the glass panel in the process. Secondly, it is also possible to use the discovery here that fine structuring may be implemented in a particularly simple manner by virtue of a corresponding pattern being able to be introduced into a tool part of the deep-drawing tool, e.g. by CNC milling, the pattern transferring to the surface of one side of the glass panel during deep drawing and it being possible to introduce arbitrary fine structures into the tool part, and hence into the glass surface, in this manner.

A wave-shaped microstructure may advantageously be implemented by virtue of the surface structure having elevations and depressions, a distance between two closest elevations in each case and between two closest depressions in each case respectively measuring between 80 and 130 micrometers. Particularly homogenous haptics and optics of the glass surface may be achieved macroscopically by way of a wave-shaped surface structure at this small length scale and, moreover, it is possible to optimize the properties of the glass surface in relation to sliding capability, sliding noises, visibility of dirt and degree of transmission. In particular, this optimization may only be provided in combination with the surface structure being embodied in such a way that a structure height of the surface structure measures between 5 and 20 micrometers. Here, structure height is understood to mean the height difference between an elevation and a depression of the surface structure in relation to a reference plane extending parallel to the macroscopic extent of the glass surface. Hence, the structure height is smaller than the structure width by one order of magnitude, as a result of which a very small local surface curvature is provided. This renders it possible to avoid the wave-like structure being felt by a user in an uncomfortable and pronounced manner, or even at all. Moreover, such a small structure height may be implemented particularly easily and quickly by deep drawing of the surface, as only a small change in form in the direction perpendicular to the glass panel needs to be obtained. Moreover, the small surface curvature may ensure that there are no optical distortions of depictions displayed through the glass panel as a result of the surface structure. Furthermore, the surface structure per se is not perceivable optically by a user.

In a further advantageous configuration, the elevations and depressions are respectively formed to be elongate in a direction of longitudinal extent, in particular so that contour lines of the surface structure mainly extend in the same direction. By way of example, this may be implemented by virtue of a pattern of grooves extending in parallel being introduced into the deep-drawing tool part. These grooves may be milled into the tool part in a particularly simple manner, as a result of which the production of such a glass panel with a wave-shaped, in particular periodic microstructure was found to be particularly simple and cost-effective.

However, it is particularly advantageous if the elevations and depressions are arranged in a grid-shaped manner such that an elevation is surrounded by four depressions, and vice versa, in particular such that contour lines of the surface structure mainly extend along a closed, in particular circular or elliptical, line. From a production engineering point of view, this may likewise be implemented very easily by virtue of further second grooves being milled into the tool part in addition to the first grooves extending in the first direction, the second grooves extending perpendicular, or at least in a range between 85° and 95°, to the first grooves. This results in a crossing pattern of grooves which is transferred to the glass surface during the deep drawing in such a way that the described grid of elevations and depressions emerges. Here, such a cross structure is advantageous, in particular in combination with the aforementioned dimensions of the structure, in that the surface structure hence has no preferred direction. Hence, this allows a particularly high degree of homogeneity to be achieved over the entire surface in terms of the haptic properties, and also in terms of optical, thermal and acoustic properties of the surface.

The method for producing a glass panel as described herein is distinguished by virtue of the fact that, when a deep-drawing tool is provided, a deep-drawing tool is provided, the first tool part of which has a pattern formed at least by the introduction of a plurality of groove-shaped first depressions. Furthermore, the glass panel is introduced into the deep-drawing tool between the first tool part and the second tool part in such a way that the pattern is transferred as a wave-shaped surface structure on the first surface of the glass panel when deep drawing the glass panel.

Hence, the method is designed for producing a glass panel of an operating element, in a particularly cost-effective and efficient manner. Here, the pattern may be introduced e.g. by milling, in particular CNC milling, in order to be able to transfer arbitrary small microstructures onto the glass panel in a simple manner. Moreover, this allows the whole surface of one side of the glass panel to be provided with a surface structure in a particularly simple manner. No restrictions are placed on the design of these microstructures in this manner; however, the groove patterns are distinguished by their particularly simple and effective implementation and, in particular, a pattern with a diagonal cross structure with the effect of an additional optimization and homogenization of the haptic, optical, thermal and acoustic properties of the resultant glass panel is therefore particularly advantageous.

Hence, in an advantageous configuration, the first depressions are introduced into the first tool part extending in a first direction and adjoining one another in a second direction perpendicular to the first direction, a respective first depression having a width in the second direction which is less than 130 micrometers. This allows a simple generation of the microstructure which is ultimately transferred to the glass panel. The widths of such grooves may, in the process, be predetermined in a simple manner by setting the milling parameters such as milling distance and milling radius. Moreover, the resultant structure height of the surface structure of the glass panel may also be predetermined in a simple manner by these parameters.

It is particularly advantageous if the pattern of the first tool part is additionally formed by introducing a plurality of groove-shaped second depressions extending in a third direction, the third direction extending at an angle not equal to zero, and may be perpendicular or at least 85° to 95°, to the first direction. In other words, a cross structure is therefore introduced into the tool part, which is then reflected in the cross-structure-like arrangement of the elevations and depressions in the glass surface.

Moreover, the deep drawing may be carried out in such a way that a second surface of the glass panel lying opposite to the first surface has a plane embodiment. Hence, only one side of the glass panel is provided with a wave-shaped surface structure, which is particularly advantageous, in particular in relation to the sensor system for the touch-sensitive operating element, coatings yet to be provided and also in relation to the stability of the glass panel.

Moreover, the glass panel may still be subject to further processing. In particular, the side of the glass panel with the surface structure may still be subject to an etching process in one, for example final, processing operation. The etching process may, for example, bring about rounding-off of possible edges of the surface structure by etching. This also allows the surface structures to be embodied in a more defined manner and, for example, the depressions of the surface structure to be made deeper and hence the structure height to be increased.

### BRIEF DESCRIPTION OF THE DRAWINGS

Further advantages, features and details will emerge from the following description of exemplary embodiments and the drawings. In the drawings:

FIG. 1a is a schematic and magnified perspective view of a glass surface with a wave-shaped microstructure in accordance with one exemplary embodiment;

FIG. 1b is a graph of the course of the surface structure in section through the glass panel along the cut line segment P1-P2 in FIG. 1a;

FIG. 2 is a schematic illustration of a diagonal cross structure of a milling pattern for introduction into a tool part of a deep-drawing tool for the purposes of generating a wave-shaped surface structure on a glass panel in accordance with one exemplary embodiment;

FIG. 3 is a schematic cross section through a groove-shaped milling pattern in a deep-drawing tool part for elucidating the milling distance and milling radius milling parameters; and

FIG. 4 is a schematic perspective view of a wave-shaped surface structure of a glass panel with elevations and depressions arranged in a grid-shaped manner in accordance with one exemplary embodiment.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

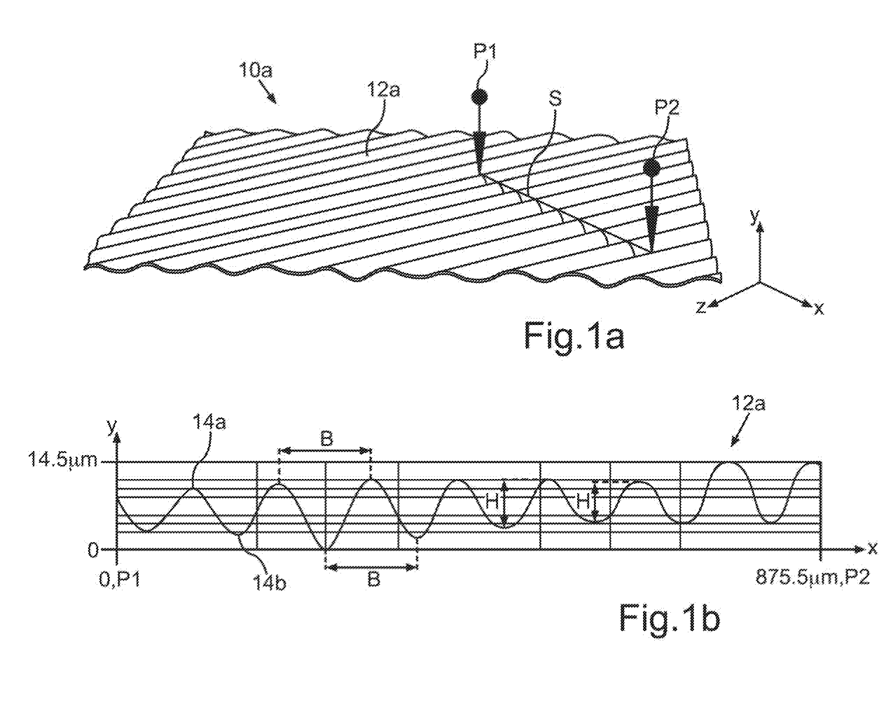

FIG. 1a shows a schematic and magnified illustration of a glass surface 10a with a wave-shaped microstructure 12a in accordance with one exemplary embodiment and FIG. 1b shows the illustration of a course of the surface structure 12a in a section through the glass panel along the cut line S, plotted in FIG. 1a, between the points P1 and P2. Here, this surface structure 12a may be generated by a deep-drawing process of the glass panel by virtue of a milling pattern in the form of grooves, which are adjacent to one another, extend in parallel in one direction and have the same shape, being introduced into one of two tool halves of a deep-drawing tool, between which the glass panel is inserted, such that this pattern is transferred as a corresponding negative form onto the glass surface 10. As a result, it is therefore possible to generate a periodic wave structure 12a with elevations 14a and depressions 14b extending on the glass surface 10a in the longitudinal direction. Furthermore, in this example, this pattern 12 is translation invariant in terms of the shaping thereof in the direction of longitudinal extent thereof, in this case in the z-direction, at least when seen within a specific tolerance range which, in particular, is smaller than the structure width B itself since such a fine structure 12a is firstly subject, in terms of the shaping thereof, to random variations and deviations, as may be gathered from the different shapes of the individual waves in FIG. 1b. Secondly, such variations and differences may also be generated in a targeted manner, e.g. by final etching of the glass surface 10 with the surface structure 12a, such that the structuring of the glass surface 10 may not be felt, or may be felt significantly less strongly, by a user as a result of such irregularities generated in a targeted manner, causing a more pleasant operating sensation.

As the scale on the x-axis in FIG. 1b further shows, the points P1 and P2 are spaced apart by 875.5 μm. The wavelengths of this structure, referred to here as structure width B, which are measured from the distance between two depressions 14b or elevations 14a in a direction, in this case the x-direction, perpendicular to the direction of longitudinal extent, in this case the z-direction, of the depressions 14b and elevations 14a, i.e., in particular, the distances between two respectively adjacent minima and maxima depicted in FIG. 1b, in this case may lie in the range between 80 μm and 130 μm and measure between 96 μm and 120 μpm in this example. The structure height H, which is likewise subject to certain variations, may be in the range between 5 μm and 20 μm in this case. In principle, it is also possible to realize structures with significantly smaller dimensions or larger dimensions. However, particularly great advantages in relation to haptics, operating sensation, optics, acoustics, the thermal properties of the glass panel, sliding properties on the surface, and hence, overall, the operability and usability of the operating element per se, may be obtained by a microstructure 12a with these dimensions.

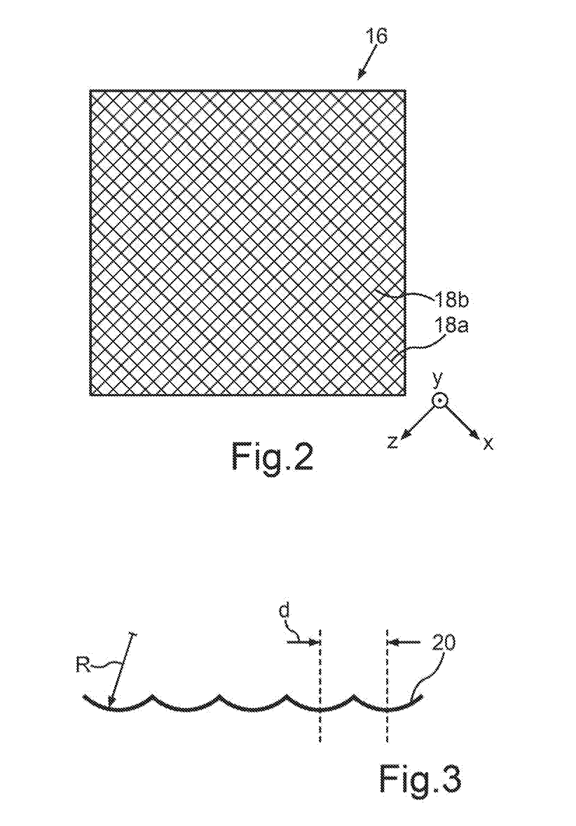

In order to further optimize these properties and provide these over the whole glass surface 10 in a particularly homogeneous manner, provision may be made of a diagonal cross structure 16, as depicted schematically in FIG. 2. In particular, a milling pattern which may be introduced into a tool part of the deep-drawing tool is depicted here in a schematic fashion. This milling pattern has first grooves 18a extending in a first direction, in this case the x-direction, and second grooves 18b extending perpendicular to these, in this case in the z-direction, which grooves may have a similar embodiment in terms of the width thereof, which corresponds to the milling distance d (cf. FIG. 3), and the depth thereof, which is predeterminable by a specific milling radius R (cf. FIG. 3). To this end, FIG. 3 shows an elucidation of these milling parameters on the basis of a schematic illustration of a cross section through a groove-shaped milling pattern 20 in a deep-drawing tool part.

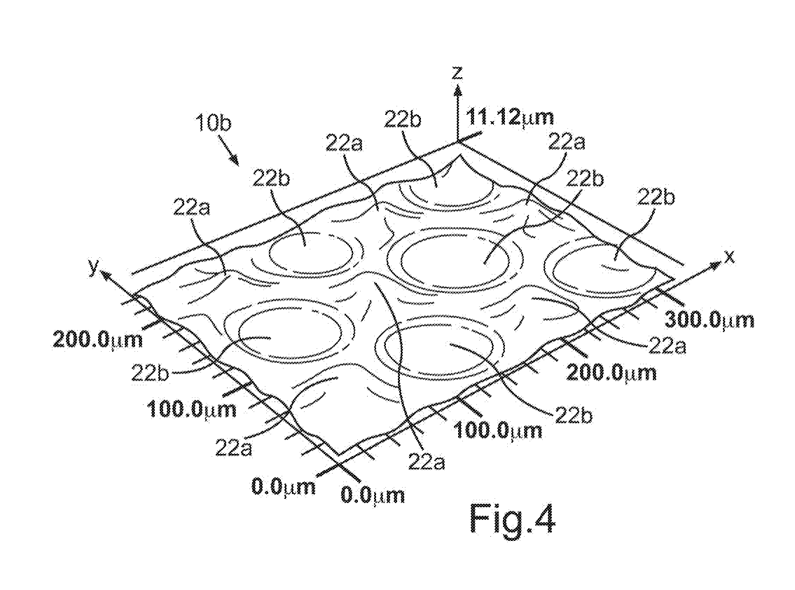

A milling pattern with a cross structure 16 as depicted in FIG. 2 may generate a surface structure 12b as depicted in FIG. 4 on a glass surface 10b by deep drawing and, in particular, by a subsequent etching process. Here, FIG. 4 shows a schematic illustration of a wave-shaped surface structure 12b of a glass panel with elevations 22a and depressions 22b arranged in a grid-shaped manner. Here, in particular, the elevations and depressions are arranged in such a way that four elevations 22a in each case surround one depression 22b, and vice versa. The edged depressions 22b possibly arising during deep drawing as a result of the milling pattern with edges may be rounded-off by a final etching and hence it is possible to generate a particularly edge-free and continuous profile of the wave structure 12b.

As a result, it is possible, overall, to provide an operating element, in particular a touchpad or a touchscreen, which has a surface optimized for touch operation in respect of sliding capability, visibility of dirt, sliding noises and sharp and clear identifiability of depictions, such as symbols for various function of the operating element, displayed through the glass panel, and which operating element further is generable in a particularly simple and cost-effective manner.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. An operating element for a motor vehicle, comprising:
a glass panel having a touch-sensitive operating surface formed by deep-drawing that produces a surface microstructure in a wave shape having elevations and depressions with a respective height therebetween of 5 to 20 micrometers and two closest elevations and two closest depressions respectively separated by between 80 and 130 micrometers.

12. The operating element as claimed in claim 11, wherein the elevations and depressions are respectively elongate in a direction of longitudinal extent producing contour lines of the surface microstructure substantially extending in a single direction.

13. The operating element as claimed in claim 11, wherein the elevations and depressions are arranged in a grid-shaped manner such that an elevation is surrounded by four depressions and a depression is surrounded by four elevations, such that contour lines of the surface structure mainly extend along a closed line.

14. A method for producing a glass panel of a touch-sensitive operating element for a motor vehicle, comprising:
providing a glass panel in a heated state;
providing a deep-drawing tool with a first tool part and a second tool part;
introducing the glass panel into the deep-drawing tool between the first tool part and the second tool part; and
forming a surface structure of a first surface of the glass panel by deep drawing the glass panel in the heated state using the deep-drawing tool to produce a touch-sensitive operating surface of the operating element on the first surface of the glass panel,
wherein the first tool part has a pattern formed at least by a plurality of groove-shaped first depressions and the glass panel is introduced into the deep-drawing tool during said introducing so that the pattern is transferred as a wave-shaped surface structure on the first surface of the glass panel when deep drawing the glass panel during said forming to produce a microstructure having elevations and depressions with a respective height therebetween of 5 to 20 micrometers and two closest elevations and two closest depressions respectively separated by between 80 and 130 micrometers.

15. The method as claimed in claim 14, wherein the groove-shaped first depressions in the first tool part extend in a first direction and adjoin one another in a second direction perpendicular to the first direction, each groove-shaped first depression having a width in the second direction of less than 130 micrometers.

16. The method as claimed in claim 15, wherein the pattern of the first tool part is additionally formed by a plurality of groove-shaped second depressions extending in a third direction, the third direction extending at an angle, not equal to zero, to the first direction.

17. The method as claimed in claim 16, wherein the third direction is perpendicular to the first direction.

18. The method as claimed in claim 14, wherein said forming by the deep drawing further produces a substantially planar second surface of the glass panel opposite to the first surface.
